(19) United States
(12) Patent Application Publication
(10) Pub. No.: US 2010/0100895 A1
(43) Pub. Date: Apr. 22, 2010

(54) Disc distribution apparatus

(76) Inventor: David R. Hernandez, Mountain House, CA (US)

Correspondence Address: THEODORE J. BIELEN JR.;BIELEN, LAMPE, & THOEMING, 1390 WILLOW PASS ROAD, SUITE 1020, CONCORD, CA, 94520, US

(21) Appl. No.: 12/288,258

(22) Filed: Oct. 17, 2008

(51) Int. Cl. G11B 17/038

(52) U.S. Cl. 720/703

(57) ABSTRACT

A distribution apparatus for a plurality of discs each having an aperture therethrough utilizing a shaft. The shaft is sized to fit within each of the apertures of the plurality of discs when such discs lie in a stacked configuration. A movable contact supported by the shaft extends from the shaft to engage the edges of the disc surrounding the apertures of the discs. Such extension of the moveable contact holds each of the discs to the shaft. A quick retraction of the movable contact releases a single disc and the remaining disc are again held by the movable contact by its subsequent extension. Feet on the shaft may hold a single disc released from the disc stack held by the moveable contact. Retraction of the feet releases a single disc from the shaft.

### BACKGROUND OF THE INVENTION

The present invention relates to a novel and useful disc distribution apparatus.

Discs are employed to store media, information, data, and the like. For example, present day discs include CDs, DVDs, Blue Rays, Digital Discs, and the like. It is often necessary to manipulate or transport such discs in conjunction with adjacent device trays, conveyers, printers, turn tables, inputs-output bins, storage devices, recording devices, labeling devices and the like. It is important to quickly and accurately distribute discs from a stack of multiple discs for use with such devices.

In the past, methods and devices have been used for handling disc or diskettes. For example, U.S. Pat. No. 5,931,400 discloses a cartridge mounting mechanism which is adaptable for microfilm machines where an element is rotated according to a gearing mechanism to position the film opposite a magnetic proximity detector.

U.S. Pat. Nos. 4,813,838, 5,520,865, and 6,024,532 show disc handling mechanisms which use stacking hoppers that allow discs to be released singly therefrom according to discharging gates.

U.S. Pat. Nos. 4,271,980, 5,518,361, and 7,032,232 describe disc handling operations in which multiple discs are stacked on a spindle or in a rack and discharged by pusher mechanism which is timed to release disc downwardly.

U.S. Pat. No. 1,158,045 describes a mechanism utilized to stack individual pieces that are flattened and includes retractable feet which allow the release of one of such flat members in a timed process.

U.S. Pat. Nos. 6,272,104, 6,820,741, and 7,234,227 illustrate disc handling devices in which a spindle is employed and oriented in an upward position. Discs may be moved singly by cams and other protrusions on the spindle.

A disc distribution apparatus which is capable of stacking and releasing discs from a downwardly positioned spindle would be a notable advance in the media industry.

### BRIEF SUMMARY OF THE INVENTION

In accordance with the present invention a novel and useful disc distribution apparatus is hereinafter provided.

The apparatus of the present invention is intended for use with a plurality of stacked discs each having an aperture therethrough. A shaft or spidnle is sized to fit within the apertures of the plurality of discs in such stacked configuration.

A movable contact such as a cam follower is supported by the shaft and is extendable, preferably by rotation, from the shaft to engage each of the plurality of discs. Such engagement may take place on the edge surrounding the aperture of each of the discs. The moveable contact is also retractable toward the shaft in order to disengage the same from the plurality of discs. When the movable contact is extended, the discs are held to the shaft by a caming or wedging action. Likewise, when the movable contact is disengage from contact with the plurality of discs, the discs are free to move downwardly, under the influence of gravity relative to the shaft. Where such movable contact is a cam follower, the surface of the cam follower may have a rounded portion and a flatten portion, the former intended to contact the edge of each disc surrounding its aperture.

At least one foot and, preferably a multiplicity of feet, are also supported by the shaft. Any of such feet are extendable from the shaft to support any of the plurality of discs not being held to the shaft by extension of the moveable contact. Again, any such feet may be rotatable outwardly and inwardly relative to the shaft to at least lie flush with the outer surface of the shaft. Any of such feet when retracted to lie flesh with the outer surface of the shaft, would allow discs supported by such feet to drop downwardly under the influence of gravity from the shaft to a designated place. The moveable contact and the at least one foot may be rotated by known servo motors or similar conventional devices such as solenoids, air cylinders, gear motors, latches and the like. Moreover, the apparatus of the present invention may be employed to pick up a multiplicity of discs and to release one or more discs, depending on the position of the moveable contact and the at least one foot supported by the shaft.

It may be apparent that a novel and useful disc distribution apparatus for a plurality of discs has been hereinabove described.

It is therefore an object of the present invention to provide a disc distribution apparatus which is capable of moving and meting any number of pluralities of discs.

A further object of the present invention is to provide a disc distribution apparatus for a plurality of discs which is capable of handling media discs such as CDs, DVDs, Blue Rays, digital discs, and the like.

Yet another object of the present invention is to provide a distribution apparatus for a plurality of discs which is compatible with other disc manipulation devices such as trays, conveyers, printers, turn tables, inputs-output bins, storage containers, recording equipment, labeling machines, and the like.

Another object of the present invention is to provide a distribution apparatus for a plurality of discs which is capable of efficiently handling multiple discs and which reduces the expenditure of time and funds.

Another object of the present invention is to provide a distribution apparatus for a plurality of discs which utilizes a minimum number of moving parts and is relatively simple to operate and maintain.

The invention possesses other objects and advantages especially as concerns particular characteristics and features thereof which will become apparent as the specification continues.

### BRIEF DESCRIPTION OF THE SEVERAL VIEWS OF THE DRAWING

FIG. 1 is a front elevational view of the apparatus of the present invention with servo motors shown schematically and a plurality of discs depicted in phantom.

FIG. 2 is a bottom plan view of the apparatus depicted in FIG. 1.

FIG. 3 is a side elevational schematic view of the apparatus of the present invention supporting five discs in stacked configuration and with the moveable contact rotated 90° from that depicted in FIG. 1, for the sake of illustration.

FIG. 4 is a side elevational schematic view similar to that of FIG. 3, in which one disc has dropped from the stack of discs onto the extended feet and the remaining discs are held to the shaft by use of the moveable contact member.

FIG. 5 is a side elevational schematic view depicting the release of one disc from the stack of discs found on the shaft and the retention of four discs by the moveable contact thereat.

FIG. 6 is a flow diagram depicting the distribution of a single disc from a stack of discs using the apparatus of the present invention.

For a better understanding of the invention reference is made to the following detailed description of the preferred embodiments of the invention which should be taken in conjunction with the above described drawings.

### DETAILED DESCRIPTION OF THE PREFERRED EMBODIMENTS OF THE INVENTION

Various aspects of the present invention will evolve from the following detailed description of the preferred embodiments thereof which should be referenced to the prior described drawings.

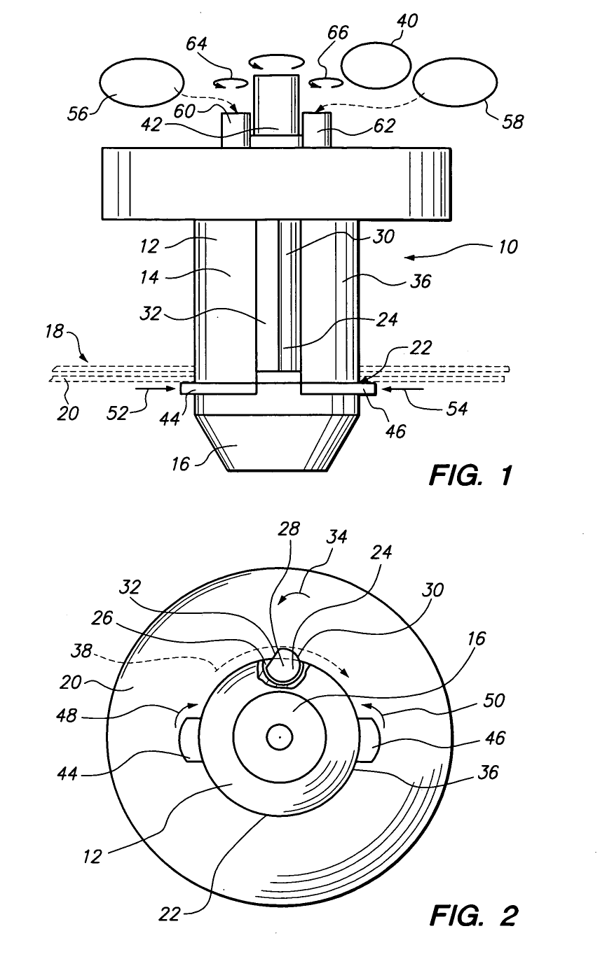

An embodiment of the invention as a whole is depicted in the drawings by reference character 10. Apparatus 10 includes as one of its elements a shaft or spindle 12 which includes an upper portion 14 of generally cylindrical configuration. Lower tip 16 of shaft 12 takes the form of a truncated cone. Shaft 12, may be formed of any suitable rigid or semi-rigid material such as plastic, metal, wood, ceramic material, and the like. Most importantly, shaft 12 includes a transverse dimension which allows shaft 12 to fit within the apertures generally centrally located in each disc of plurality of discs 18. For example, disc 20 includes a central aperture 22 of circular configuration, FIGS. 1 and 2.

Apparatus 10 also utilizes a moveable contact 24 which is supported by shaft 12 in an open chamber 26, FIG. 2. Moveable contact rotates about axis 28. Moreover, moveable contact 24 includes a rounded outer surface 30 and a flattened outer surface 32. Rotation of moveable contact 24, directional arrow 34, either positions moveable contact 24 flush with or within outer surface 36 of shaft 12 (flattened surface 32 exposed) or extended beyond outer surface 36 of shaft 12 (rounded outer surface 30 exposed). In the latter configuration, moveable contact 24 catches the circular edges surrounding the apertures of each of the plurality of discs 18 that are laterally positioned relative to contact 24. With reference with FIG. 2, it may be observed that edge 38 surrounding aperture 22 of disc 20 is partially depicted in FIG. 2, in this regard. Needless to say, such engagement between edge 38, as well as other similar edges of plurality of discs 18, hold such discs to shaft 12. Visa versa, the exposure of flattened portion 32 of moveable contact 24 and retraction of moveable contact 24 into chamber 26 will release any of plurality of discs 18. Servo motor 40, depicted schematically in FIG. 1, of conventional configuration, rotates Rod 42, which in turn rotates moveable contact 24.

Feet 44 and 46 also rotate according to directional arrows 48 and 50 respectively, FIG. 2. Such rotation essentially either extends feet 44 and 46 relative to outer surface 36 of shaft 12 or retracts feet 44 and 46 to position that is within or flush to the outer surface 36 of shaft 12. As depicted in FIGS. 1 and 2, feet 44 and 46 have been extended to underlie plurality of discs 18 and thus, to support the same when such plurality of discs 18 are not being held by moveable contact 24. FIG. 1, depicts the holding of disc 20 on feet 44 and 46. Directional arrows 52 and 54, FIG. 1, indicate that the rotation of feet 44 and 46 will retract the same at least flush with outer surface 36 of shaft 12. Servo motors 56 and 58 turn Rods 60 and 62 respectively, according to directional arrows 64 and 66. Rod 60 and 62 connect to feet 44 and 46 respectively. Again, servo motors 56 and 58 are depicted schematically and are of conventional configuration known in the art.

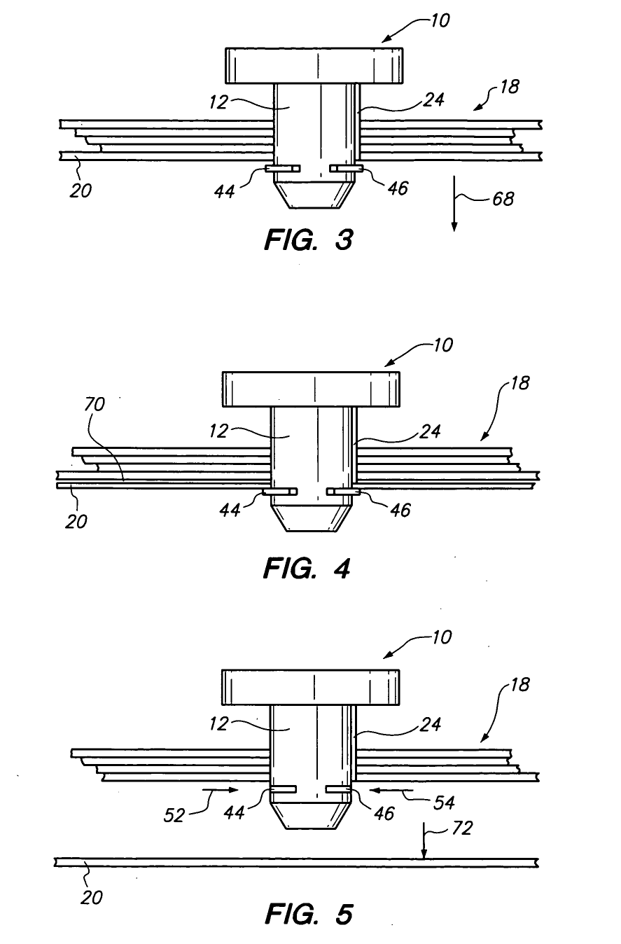

Turning now to FIGS. 3-5, a partial operation of device 10 is depicted. It should be noted that on FIGS. 3-5, moveable contact 24 has been rotated 90° from that shown in FIGS. 1 and 2 in order to illustrate the operation of device 10. It should also be realized, that the relative position of moveable contact 24 on shaft 12 relative to feet 44 and 46 is not restricted to that shown on FIGS. 1 and 2.

In operation, apparatus 10, is shown in FIGS. 3-5 where moveable contact 24 has been extended against the inner edges of plurality of disc 18, exemplified by edge 38 of disc 20. In this configuration, the rounded outer surface 30 of moveable contact 24 has been extended via servo motor 40 and Rod 42. The subsequent retraction of moveable contact 24, which may be considered a cam follower, results in the exposure of flattened surface 32 which lies flush or within shaft 12. Such retraction of moveable contact 24 releases a plurality of discs 18 and allows them to drop according to directional arrow 68, FIG. 3. Moveable feet 44 and 46 are then extended as shown in FIG. 3, to catch one or more discs from plurality of disc 18. As depicted in FIG. 4, a single disc 20 has dropped onto feet 44 and 46 and moveable contact 24 has again been extended through rotation to hold the remaining discs of plurality of discs 18 above disc 20. It should be realized that the remaining plurality of discs 18, other than disc 20, may lie atop disc 20 in this regard. However, a slight gap 70 is shown in FIG. 4, in order to distinguish the released disc 20 from the remainder of plurality of disc 18. Turning to FIG. 5, it may be observed that moveable contact 24 remains extended and feet 44 and 46 have been retracted by the rotation of Rods 60 and 62, respectively via servo motors 56 and 58. Such movement of feet 44 and 46 releases disc 20 from apparatus 10 for further processing as described hereinabove. Directional arrow 72 indicates such movement of disc 20.

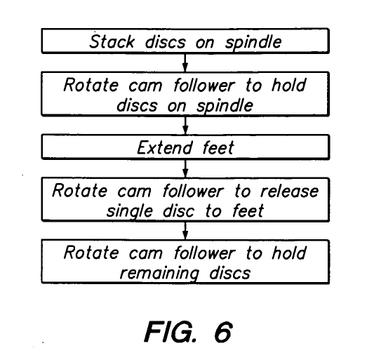

FIG. 6, illustrates a sample sequence of events which may take place with apparatus 10. Discs are stacked on spindle or shaft 12 by retracting feet 44 and 46, retracting moveable contact 24, and lowering shaft or spindle 12 into plurality of disc 18 in a neatly stacked configuration. Again, the movement of shaft 12 in this manner may be accomplished by manual or mechanical means of known configuration. At this point, cam follower or moveable contact 24 is rotated to hold plurality of disc 18 on shaft or spindle 12. Shaft 12 may also be moved away from the initial position of plurality of disc 18 upwardly or laterally as required in a typical processing of plurality of disc 18. Feet 44 and 46 is then extended followed by the further rotation of moveable contact or cam follower 24 to allow plurality of disc to rest on feet 44 and 46 or to allow a single disc to rest on feet 44 and 46 should moveable contact 24 be rotated quickly to hold the remainder of plurality of discs 18 on shaft 12. Feet 44 and 46, are then retracted to release a disc or discs supported by feet 44 and 46 with or without the movement of shaft 12, commensurate with the particular process being carried out with respect to plurality of discs 18.

While in the foregoing, embodiments of the present invention have been set forth in considerable detail for the purposes of making a complete disclosure of the invention, it may be apparent to those of skill in the art that numerous changes may be made in such detail without departing from the spirit and principles of the invention.

What is claimed is:

1. A distribution apparatus for a plurality of discs each having an aperture therethrough comprising:
a. a shaft, said shaft being sized to fit within each of the apertures of the plurality of discs lie in a stacked configuration;
b. a movable contact, said movable contact being supported by said shaft, said movable contact being extendable from said shaft to engage each of said plurality of discs in the vicinity of each of the apertures of the disc and to hold the plurality of discs to said shaft thereby, said movable contact further being retractable to disengage from the plurality of discs to release said disc from said shaft for free movement of the disc relative to said shaft; and
c. at least one foot, said one foot being supported by said shaft, said one foot being extendable from said shaft to support any of said plurality of discs not being held to said shaft by extension of said movable contact.

2. The apparatus of claim 1 in which said movable contact is rotatable.

3 The apparatus of claim 1 in which said one foot is rotatable.

4. The apparatus of claim 3 in which said movable contact is rotatable.

5. The apparatus of claim 4 which additionally comprises one another for controlling the motion of said movable contact.

6. The apparatus of claim 5 which additionally comprises another motor for controlling the motion of said one foot.

7. The apparatus of claim 6 in which said movable contact is rotatable.

8. The apparatus of claim 6 in which said one foot is rotatable.

9. The apparatus of claim 8 in which said movable contact is rotatable.

10. The device of claim 1 in which each of the apertures of the plurality of discs form a cam edge surface at the periphery of each aperture, and said movable contact comprises a cam follower being capable riding on said cam edge surface.

11. The apparatus of claim 10 in which said movable contact is rotatable.

12. The apparatus of claim 11 in which said one foot is rotatable.

13. The apparatus of claim 12 which additionally comprises one another for controlling the motion of said movable contact.

14. The apparatus of claim 13 which additionally comprises another motor for controlling the motion of said one foot.
